(19) United States
(12) Patent Application Publication
(10) Pub. No.: US 2014/0271384 A1
(43) Pub. Date: Sep. 18, 2014

(54) System and Methods for using Copper- Manganese- Iron Spinel as Zero PGM Catalyst for TWC Applications

(71) Applicants: Zahra Nazarpoor, Camarillo, CA (US); Stephen J. Golden, Santa Barbara, CA (US)

(72) Inventors: Zahra Nazarpoor, Camarillo, CA (US); Stephen J. Golden, Santa Barbara, CA (US)

(73) Assignee: CDTI, Ventura, CA (US)

(21) Appl. No.: 14/098,084

(22) Filed: Dec. 5, 2013

Related U.S. Application Data
(63) Continuation-in-part of application No. 13/849,169, filed on Mar. 22, 2013.
Application No. 13/849,169 is a continuation-in-part of application No. 13/849,230, filed on Mar. 22, 2013.
(60) Provisional application No. 61/791,721, filed on Mar. 15, 2013.
(60) Provisional application No. 61/791,838, filed on Mar. 15, 2013.

(51) Int. Cl. B01J 23/889

(52) U.S. Cl. CPC B01J 23/8892
USPC 422/168; 502/324

(57) ABSTRACT

A Cu—Mn—Fe spinel on a plurality of support oxides is disclosed as ZPGM catalyst. The active phase for ZPGM samples may be Cu—Mn—Fe spinel on ZrO₂ or Niobium-Zirconia support oxide. TWC activity may be increased and the effect of support oxide on performance of Cu—Mn—Fe spinel optimized to provide enhanced levels of NO, CO, and HC conversion even when compared to materials used for binary systems of Cu—Mn spinel. Cu—Mn—Fe spinel on support oxide provides optimal and stable spinel phase at a range of temperatures below 900° C. Bulk powder material including the disclosed ternary system may provide active catalyst for TWC applications having a chemical composition substantially free from PGM for cost effective manufacturing.

### CROSS-REFERENCE TO RELATED APPLICATIONS

This application is a continuation-in-part of U.S. patent application Ser. Nos. 13/849,169 and 13/849,230, filed Mar. 22, 2013, respectively, and claims priority to U.S. Provisional Application Nos. 61/791,721 and 61/791,838, filed Mar. 15, 2013, respectively, and is related to U.S. patent application Ser. No. 14/090,861, filed Nov. 26, 2013, entitled System and Methods for Using Synergized PGM as a Three-Way Catalyst.

### BACKGROUND

1. Field of the Disclosure

This disclosure relates generally to ZPGM catalyst materials, and, more particularly, to formation of Cu—Mn—Fe spinel phase and thermal stability of Cu—Mn—Fe spinel for use in three-way catalyst (TWC) applications.

2. Background Information

Catalysts to control toxic emissions have a composite structure consisting of transition metal nano-particles or ions dispersed and supported on the surface of a support material. Said support materials are either micro-particles with a very large specific surface area or a highly porous matrix. A requirement for the materials used is that the catalyst exhibits a very high level of heat resistance and be capable of ensuring stability and reliability in long-term service. Currently, at higher temperatures at which the catalyst functions, the catalytic centers become massed together or agglomerated, which in turn decreases the effective surface area to result in the gradual degradation of the catalytic functions.

Catalyst systems for TWC applications are generally fabricated using platinum group metals (PGM), such as platinum (Pt), palladium (Pd), and rhodium (Rh), amongst others, which may have excellent oxidation activity, but are characterized by a small market circulation volume, constant fluctuations in price, and constant risk to stable supply, variables that drive up their cost. These facts lead to the realization of catalysts that are substantially free from PGM.

Catalytic materials used in TWC applications have changed, and the new materials have to be thermally stable under the fluctuating exhaust gas conditions. The attainment of the requirements regarding the techniques to monitor the degree of the catalyst's deterioration/deactivation demands highly active and thermally stable catalysts.

According to the foregoing reasons, there is a continuing need for materials able to perform in a variety of environments using synergistic effects derived from tools of catalyst design and synthesis methods, as well as it may be desirable to have catalyst systems that may include a new generation of materials. These are very important elements for the advancement of TWC technology to effect emission reduction across a range of temperature and operating conditions, while maintaining or even improving upon the thermal and chemical stability under normal operating conditions and up to the theoretical limit in real catalysts.

### SUMMARY

The present disclosure may provide a Cu—Mn—Fe spinel structure supported on a plurality of support oxides. Disclosed Cu—Mn—Fe spinel structures on support oxide may show optimal properties for ZPGM catalysts that may be used in TWC applications. In present disclosure, the active phase for ZPGM may be the disclosed Cu—Mn—Fe spinel structure supported on a plurality of support oxides.

The Cu—Mn—Fe spinel compositions may be prepared with appropriate precipitation method, dried and calcined at different temperatures. The Cu—Mn—Fe compositions on support oxides may be subsequently ground to fine powder for XRD analysis. According to embodiments in the present disclosure, in order to determine spinel phase formation and stability, powder samples of Cu—Mn—Fe spinel structure on support oxide may be prepared using the general formulation CuₓMn₁₋ₓFe₂O₄, where X may preferably take a value of 0.5.

XRD analysis may provide the temperature at which Cu—Mn—Fe spinel phase may be formed, as well as the temperature at which the Cu—Mn—Fe spinel may be stable. The temperature of spinel formation may be used as the temperature of firing during catalyst manufacturing, and the temperature of stability may point to a selected application.

In another aspect of present disclosure, the optimal NO/CO cross over R-value of disclosed Cu—Mn—Fe spinel structure on support oxide may be determined by performing isothermal steady state sweep test, which may be enabled at a selected inlet temperature using an 11-point R-value from rich condition to lean condition, at a plurality of space velocities. Results for disclosed Cu—Mn—Fe spinel structure on support oxide may be compared with results for Cu—Mn spinel on support oxide, under same condition, to show the effect of adding Fe to Cu—Mn spinel by the disclosed Cu—Mn—Fe spinel structure on support oxide.

According to another embodiment, TWC standard light-off test may be performed for disclosed Cu—Mn—Fe spinel structure on support oxides. Standard light-off test may be performed under steady state condition, at a selected R-value of NO/CO cross over for enhanced catalytic activity in NO, CO, and HC conversion. Comparison of catalytic activity may be developed for Cu—Mn—Fe spinel on different support oxides, as may be shown by T₅₀ values resulting when the effect on TWC activity is measured/analyzed for different support oxides.

Although the catalytic activity and thermal stability of a ZPGM catalyst during real use may be affected by factors such as the chemical composition of the catalyst, it is desirable to increase TWC activity. According to principles in present disclosure, support oxides may have an effect on performance of disclosed Cu—Mn—Fe spinel. The TWC property of the disclosed Cu—Mn—Fe spinel may provide an indication that for catalyst applications, catalyst systems including disclosed spinel may be more efficient operationally-wise, and from a catalyst manufacturer's viewpoint, an essential advantage given the economic factors involved.

Numerous other aspects, features, and benefits of the present disclosure may be made apparent from the following detailed description taken together with the drawing figures, which may illustrate the embodiments of the present disclosure, incorporated herein for reference.

### BRIEF DESCRIPTION OF THE DRAWINGS

The present disclosure can be better understood by referring to the following figures. The components in the figures are not necessarily to scale, emphasis instead being place upon illustrating the principles of the disclosure. In the figures, reference numerals designate corresponding parts throughout the different views.

FIG. 1 shows XRD analysis for spinel phase formation and phase stability of Cu_{0.5}Mn_{0.5}Fe₂O₄ spinel, supported on ZrO₂, at different firing temperatures, according to an embodiment.

FIG. 2 shows XRD analysis for spinel phase formation and phase stability of ZPGM catalyst samples of Cu_{0.5}Mn_{0.5}Fe₂O₄ spinel supported on Nb₂O₅—ZrO₂, at different firing temperatures, according to an embodiment.

FIG. 3 depicts sweep test performance comparison for samples of Cu_Mn_Fe spinel and Cu—Mn spinel, both supported on ZrO₂, under isothermal steady state sweep condition, at inlet temperature of about 450° C. and space velocity (SV) of about 90,000 h⁻¹, according to an embodiment.

FIG. 4 depicts comparison of TWC standard steady state light-off test results for ZPGM catalyst samples of Cu_Mn_Fe spinel and Cu—Mn spinel, both supported on Nb₂O₅—ZrO₂, at SV of about 40,000 h⁻¹, and R-value of about 1.20, according to an embodiment.

FIG. 5 illustrates comparison of TWC standard steady state light-off test results for ZPGM catalyst samples of Cu_{0.5}Mn_{0.5}Fe₂O₄ spinel supported on ZrO₂ and Cu_{0.5}Mn_{0.5}Fe₂O₄ spinel supported on Nb₂O₅—ZrO₂, at SV of about 40,000 h⁻¹, and R-value of about 1.20, according to an embodiment.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Platinum group metal (PGM)” refers to platinum, palladium, ruthenium, iridium, osmium, and rhodium.

“Zero platinum group (ZPGM) catalyst” refers to a catalyst completely or substantially free of platinum group metals.

“Catalyst” refers to one or more materials that may be of use in the conversion of one or more other materials.

“Co-precipitation” may refer to the carrying down by a precipitate of substances normally soluble under the conditions employed.

“Calcination” refers to a thermal treatment process applied to solid materials, in presence of air, to bring about a thermal decomposition, phase transition, or removal of a volatile fraction at temperatures below the melting point of the solid materials.

“Treating, treated, or treatment” refers to drying, firing, heating, evaporating, calcining, or mixtures thereof.

“Spinel” refers to any of various mineral oxides of magnesium, iron, zinc, or manganese in combination with aluminum, chromium, copper or iron with AB₂O₄ structure.

“Conversion” refers to the chemical alteration of at least one material into one or more other materials.

“R-value” refers to the number obtained by dividing the reducing potential by the oxidizing potential of materials in a catalyst.

“Rich condition” refers to exhaust gas condition with an R-value above 1.

“Lean condition” refers to exhaust gas condition with an R-value below 1.

“Air/Fuel ratio” or “A/F ratio” refers to the weight of air divided by the weight of fuel.

“Three-way catalyst (TWC)” refers to a catalyst that may achieve three simultaneous tasks: reduce nitrogen oxides to nitrogen and oxygen, oxidize carbon monoxide to carbon dioxide, and oxidize unburnt hydrocarbons to carbon dioxide and water.

“T₅₀” may refer to the temperature at which 50% of a material is converted.

“X-ray diffraction or XRD analysis” refers to the analytical technique that investigates crystalline material structure, including atomic arrangement, crystalline size, and imperfections in order to identify unknown crystalline materials (e.g. minerals, inorganic compounds).

### DESCRIPTION OF THE DRAWINGS

The present disclosure may provide a ZPGM material composition including a formulation to form a Cu—Mn—Fe spinel, supported on a plurality of support oxides. The Cu—Mn—Fe compositions on support oxides may be ground to fine powder for XRD analysis. This process may provide the temperature at which Cu—Mn—Fe spinel may be formed, as well as the temperature at which the spinel may be stable to select optimal TWC application of Cu—Mn—Fe spinel. The temperature of spinel formation may be used as the temperature of firing during catalyst manufacturing, and the temperature of stability may point to a selected underfloor application.

Cu—Mn—Fe Material Compositions on Support Oxide and Preparation

The disclosed ZPGM material compositions in form of bulk powder in the present disclosure may be prepared as Cu—Mn—Fe spinel on support oxides via co-precipitation method. The powder material may be prepared from a stoichiometric or non-stoichiometric Cu—Mn—Fe spinel structure using variations of Cu—Mn—Fe molar ratios in the general formulation CuₓMn₁₋ₓFe₂O₄, where X may be variable of different molar ratios within a range of about 0.1<x<0.9. In present disclosure, preferably, X may have a value of 0.5.

Cu—Mn—Fe solution may be prepared by mixing the appropriate amount of Mn nitrate solution (Mn(NO₃)₂), Cu nitrate solution (CuNO₃), and Fe nitrate (Fe(NO₃)₃) with water to make solution at different molar ratios according to formulation CuₓMn₁₋ₓFe₂O₄. The solution of Cu, Mn, and Fe nitrates may be subsequently added to a plurality of support oxides, such as ZrO₂, or Nb₂O₅—ZrO₂ support oxides, among others. Then, appropriate amount of one or more of sodium hydroxide (NaOH) solution, sodium carbonate (Na₂CO₃) solution, ammonium hydroxide (NH₄OH) solution, tetraethyl ammonium hydroxide (TEAH) solution and other suitable base solutions may be added to adjust pH of the solution at desired value. The precipitated slurry may be aged overnight while stirring at room temperature.

For preparation of Cu—Mn—Fe bulk powder, after aging and stirring, the slurry may undergo filtering and washing with distilled water. The resulting material may be dried overnight at about 120° C. and subsequently calcined at a plurality of temperatures within a range of about 500° C. to about 1,000° C. for about 5 hours. The prepared material at different calcination temperatures may be subsequently ground to fine grain to form bulk powder.

XRD Analysis for Cu—Mn—Fe Spinel Phase Formation and Stability

Spinel phase formation and phase stability of the Cu—Mn—Fe spinel phase may be subsequently analyzed/measured using X-ray diffraction (XRD) analyses. The plurality of variations in present disclosure that may result from successive XRD analysis may produce corresponding phase diagrams. XRD data may then be analyzed and a new phase may be determined and selected in conformity with a different calcination temperature. This calibration may lead to improved variations to produce optimal performance and durability of catalysts including Cu—Mn—Fe spinel on support oxides. The XRD analysis may be conducted to determine the phase structure Cu—Mn—Fe materials on support oxides that according to principles in the present disclosure may be calcined at temperatures within the range of about 500° C. to about 1,000° C. for about 5 hours.

The XRD patterns may be measured on a Rigaku® powder diffractometer (MiniFlex™) using Cu Ka radiation in the 2-theta range of about 15°-100° with a step size of 0.02° and a dwell time of 1 second. The tube voltage and current were set at 40 kV and 30 rnA, respectively. The resulting diffraction patterns may be analyzed using the International Centre for Diffraction Data (ICDD) database. The effect of calcining (firing) temperature in the phase stability of the Cu—Mn—Fe spinel phase, using support oxides for all Cu—Mn—Fe spinel structures, may be analyzed/measured using XRD analysis to confirm the spinel phase formation and phase stability of all Cu—Mn—Fe spinel structures in present disclosure.

XRD analysis may also provide an indication that for catalyst applications the chemical composition of the Cu—Mn—Fe spinel on support oxide may show enhanced stability at a plurality of temperatures of operation in TWC applications.

Isothermal Steady State Sweep Test Procedure

In present disclosure, isothermal steady state sweep test may be carried out, for samples of disclosed Cu—Mn—Fe spinel on support oxide, employing a flow reactor at inlet temperature of about 450° C., and testing a gas stream at 11-point R values from about 1.40 (rich condition) to about 0.90 (lean condition) to measure the CO, NO, and THC conversions.

The space velocity (SV) in the isothermal steady state sweep test may be adjusted at about 90,000 h⁻¹. The gas feed employed for the test may be a standard TWC gas composition, with variable O₂ concentration in order to adjust R-value from rich condition to lean condition during testing. The standard TWC gas composition may include about 8,000 ppm of CO, about 400 ppm of C₃H₆, about 100 ppm of C₃H₈, about 1,000 ppm of NOₓ, about 2,000 ppm of H₂, 10% of CO₂, and 10% of H₂O. The quantity of O₂ in the gas mix may be varied to adjust Air/Fuel (A/F) ratio.

Results from isothermal steady state sweep test for samples of disclosed Cu—Mn—Fe spinel on support oxide may be compared to results from samples of Cu—Mn spinel on same type of support oxide to verify enhanced activity of the disclosed Cu—Mn—Fe spinel on support oxide.

TWC Standard Light-Off Test Procedure

TWC standard light-off test under steady state condition may be performed, for samples of disclosed Cu—Mn—Fe spinel on support oxide, employing a flow reactor in which temperature may be increased from about 100° C. to about 500° C. at a rate of about 40° C./min, feeding a gas composition of 8,000 ppm of CO, 400 ppm of C₃H₆, 100 ppm of C₃H₈, 1,000 ppm of NO, 2,000 ppm of H₂, 10% of CO₂, 10% of H₂O, and 0.7% of O₂. The average R-value is 1.20, at SV of about 40,000 h⁻¹.

In present disclosure, TWC standard light of test procedure may be used as a verification for the effect of adding of Fe to Cu—Mn spinel in increasing TWC activity and the effect of support oxides on performance of Cu—Mn—Fe spinel.

The following examples are intended to illustrate the scope of the disclosure. It is to be understood that other procedures known to those skilled in the art may alternatively be used.

### EXAMPLES

### Example #1

### Cu_{0.5}Mn_{0.5}Fe₂O₄ Spinel on ZrO₂ Support Oxide

Cu—Mn—Fe solution may be prepared by mixing the appropriate amount of Mn nitrate solution (Mn(NO₃)₂), Cu nitrate solution (CuNO₃), and Fe nitrate (Fe₃NO₃) with water to make solution at specific molar ratio according to formulation CuₓMn₁₋ₓFe₂O₄, in which X may preferably take a value of 0.5. For preparation of bulk powder including Cu_{0.5}Mn_{0.5}Fe₂O₄ with ZrO₂ support oxide, after ZrO₂ support oxide is added to Cu—Mn—Fe solution, an appropriate amount of NaOH solution may be added to adjust pH of slurry. Then, precipitated slurry may be aged overnight while stirring at room temperature. Afterwards, slurry may undergo filtering and washing with distilled water, followed by drying overnight at about 120° C., and subsequently, calcination at selected temperatures of about 600° C. and about 900° C. for about 5 hours. The prepared powder at different calcination temperatures may be subsequently ground to fine grain to form bulk powder.

XRD Analysis for Cu—Mn—Fe Spinel on ZrO₂ Support Oxide

FIG. 1 shows XRD analysis 100 for spinel phase formation and spinel phase stability of Cu_{0.5}Mn_{0.5}Fe₂O₄ with ZrO₂ support oxide in example #1, at different firing temperatures, according to an embodiment. XRD spectrum 102 shows ZPGM catalyst powder of Example#1 calcined at temperature of about 600° C. and XRD spectrum 104 shows ZPGM catalyst powder of Example#1 calcined at temperature of about 900° C.

As may be observed in FIG. 1, Solid lines 106 correspond to Cu_{0.5}Mn_{0.5}Fe₂O₄ spinel, the remaining diffraction peaks in XRD spectrum 102 and XRD spectrum 104 correspond mostly to a phase of ZrO₂ support oxide.

As seen, presence of Cu_{0.5}Mn_{0.5}Fe₂O₄ spinel at about 600° C. and at about 900° C., as shown by solid lines 106, indicates that the formation of Cu—Mn—Fe spinel at 600° C. and the spinel phase stability at 900° C. on ZrO₂ support oxide.

### Example #2

### Cu_{0.5}Mn_{0.5}Fe₂O₄ Spinel on Nb₂O₅—ZrO₂ Support

Cu—Mn—Fe solution may be prepared by mixing the appropriate amount of Mn nitrate solution (Mn(NO₃)₂), Cu nitrate solution (CuNO₃), and Fe nitrate (Fe₃NO₃) with water to make solution at specific molar ratio according to formulation CuₓMn₁₋ₓFe₂O₄, in which X may preferably take a value of 0.5. For preparation of bulk powder including Cu_{0.5}Mn_{0.5}Fe₂O₄ with Nb₂O₅—ZrO₂ support oxide, after Nb₂O₅—ZrO₂ support oxide is added to Cu—Mn—Fe solution, an appropriate amount NaOH solution may be added to adjust pH of slurry. Then, precipitated slurry may be aged overnight while stirring at room temperature. Afterwards, slurry may undergo filtering and washing with distilled water, followed by drying overnight at about 120° C., and subsequently, calcination at selected temperatures of about 600° C., about 800° C., and about 900° C., for about 5 hours. The prepared material at different calcination temperatures may be subsequently ground to fine grain to form bulk powder.

XRD Analysis for Cu—Mn—Fe Spinel on Nb₂O₅—ZrO₂ Support Oxide

FIG. 2 shows XRD analysis 200 for spinel phase formation and spinel phase stability of Cu_{0.5}Mn_{0.5}Fe₂O₄ with Nb₂O₅—ZrO₂ support oxide in example #2, at different firing temperatures, according to an embodiment. XRD spectrum 202 shows ZPGM catalyst powder of Example#2 calcined at temperature of about 600° C.; XRD spectrum 204 shows ZPGM catalyst powder of Example#2 calcined at temperature of about 800° C.; and XRD spectrum 206 shows ZPGM catalyst powder of Example#2 calcined at temperature of about 900° C.

As may be observed in FIG. 2, Solid lines 208 correspond to Cu_{0.5}Mn_{0.5}Fe₂O₄ spinel, the remaining diffraction peaks in XRD spectrum 202, XRD spectrum 204, and XRD spectrum 206 correspond mostly to a phase of Nb₂O₅—ZrO₂ support oxide.

As seen, presence of Cu_{0.5}Mn_{0.5}Fe₂O₄ spinel at about 600° C., at about 800° C., and at about 900° C., as shown by solid lines 208, indicates that the formation Cu—Mn—Fe spinel on Nb₂O₅—ZrO₂ support oxide occurs at low temperature as 600° C. and the spinel phase is stable by increasing the temperature to 800° C. and 900° C.

Sweep Test Comparison: Effect of Fe on Cu—Mn Spinel

FIG. 3 shows Sweep test comparison 300 for samples of Cu_{0.5}Mn_{0.5}Fe₂O₄ spinel with ZrO₂ support oxide, per example #1, and samples of Cu—Mn spinel with ZrO₂ support oxide, under isothermal steady state sweep condition, at inlet temperature of about 450° C. and space velocity (SV) of about 90,000 h⁻¹, according to an embodiment. FIG. 3A shows results for samples of Cu_Mn_Fe spinel on ZrO₂ support oxide, and FIG. 3B shows results for catalyst samples of Cu—Mn spinel on ZrO₂ support oxide.

In FIG. 3A, test results of percent conversions for disclosed ZPGM Cu—Mn—Fe spinel active phase on ZrO₂ support oxide have been identified with solid lines, as NO curve 302, CO curve 304, and HC curve 306. The NO/CO cross over takes place at the specific R-value of about 1.22 where both NO and CO conversion is about 96.5%. To compare the effect of addition of third element, Fe, to Cu—Mn spinel, FIG. 3B, shows the results of percent conversion of ZPGM Cu—Mn spinel on ZrO₂ support oxide, identified with solid lines, as NO curve 308, CO curve 310, and HC curve 312. The NO/CO cross over for Cu—Mn spinel takes place at the specific R-value of about 1.4 where NOₓ and CO conversion is about 96.5%

As may be observed from FIG. 3A and FIG. 3B, results of higher NO/CO cross over R-values and lower levels of NOx, CO, and HC conversions obtained from samples of Cu—Mn spinel on ZrO₂ support oxide confirm that Cu—Mn—Fe spinel on ZrO₂ support oxide exhibit an enhanced catalyst performance in TWC conversion by providing optimal activity TWC condition. Optimal activity under close to stoichiometric condition for Cu—Mn—Fe spinel structure on ZrO₂ support oxide in example #1 can be observed at R-value 1.1 as example. At this R-value, NO conversion, for disclosed Cu—Mn—Fe spinel is about 78.3%. At same R-value of 1.1, NO conversion, for Cu—Mn spinel is about 30.4%. Comparison of NO conversion indicates that addition of Fe to Cu—Mn spinel has a synergistic effect in enhancing TWC activity.

TWC Light-Off Comparison: Effect of Adding Fe to Cu—Mn Spinel

FIG. 4 depicts TWC performance comparison 400 for samples of Cu_{0.5}Mn_{0.5}Fe₂O₄ spinel on Nb₂O₅—ZrO₂ support oxide in example #2 and Cu—Mn spinel on Nb₂O₅—ZrO₂ support oxide, under TWC standard steady state light-off condition, at SV of about 40,000 h⁻¹, and R-value of about 1.20, according to an embodiment.

As may be seen in FIG. 4, NO, CO, and HC conversion curves for samples of Cu—Mn spinel supported on Nb₂O₅—ZrO₂ support oxide have been identified with dash lines, as NO curve 402, CO curve 404, and HC curve 406.

As may be observed, in NO curve 402, NO T₅₀ occurs at approximately 424° C. and in CO curve 404, CO T₅₀ takes place at about 185° C., and in HC curve 406, HC T₅₀ occurs at approximately 450° C. or may be slightly higher.

NO, CO, and HC conversion curves for samples of Cu—Mn—Fe spinel on Nb₂O₅—ZrO₂ support oxide, under steady state light-off test condition, are identified with solid lines as NO curve 408, CO curve 410, and HC curve 412.

As may be observed, in NO curve 408, NO T₅₀ occurs at about 400° C., in CO curve 410, CO T₅₀ takes place at of about 180° C., and in HC curve 412, HC T₅₀ occurs at about 300° C.

A comparison of results of NO, CO, and HC T₅₀ indicates and verifies that samples of Cu—Mn—Fe spinel on Nb₂O₅—ZrO₂ support oxide are more effective than samples of Cu—Mn spinel on Nb₂O₅—ZrO₂ support oxide. The lower temperatures T₅₀ for samples of Cu—Mn—Fe spinel on Nb₂O₅—ZrO₂ support oxide also confirm an improved ZPGM catalyst activity obtained from the cooperative effect of adding Fe to Cu—Mn spinel on Nb₂O₅—ZrO₂ support oxide.

TWC Light-Off Comparison: Effect of Support Oxide on Performance of Cu—Mn—Fe Spinel

FIG. 5 illustrates TWC performance comparison 500 for samples of Cu_{0.5}Mn_{0.5}Fe₂O₄ spinel on ZrO₂ support oxide in example #1 and Cu_{0.5}Mn_{0.5}Fe₂O₄ spinel on Nb₂O₅—ZrO₂ support oxide in example #2, under TWC standard steady state light-off condition, at SV of about 40,000 h⁻¹, and R-value of about 1.20, according to an embodiment.

As may be seen in FIG. 5, NO, CO, and HC conversion curves for disclosed catalyst of example#1 have been identified with dash lines, as NO curve 502, CO curve 504, and HC curve 506.

As may be observed, in NO curve 502, NO T₅₀ occurs at about 420° C. and in CO curve 504, CO T₅₀ takes place at about 215° C., and in HC curve 506 HC T₅₀ takes place at about 433° C.

NO, CO, and HC conversion curves for samples of Cu—Mn—Fe spinel on Nb₂O₅—ZrO₂ support oxide, under steady state light-off test condition, are identified with solid lines as NO curve 508, CO curve 510, and HC curve 512.

As may be observed, in NO curve 508, NO T₅₀ conversion occurs at about 400° C., in CO curve 510, CO T₅₀ conversion takes place at of about 180° C., and in HC curve 512, HC T₅₀ conversion occurs at about 300° C.

A comparison of results of NO, CO, and HC T₅₀ indicates and verifies that samples of Cu—Mn—Fe spinel on Nb₂O₅—ZrO₂ support oxide are more effective than samples of Cu—Mn—Fe spinel on ZrO₂ support oxide. The lower temperatures T₅₀ for samples of Cu—Mn—Fe spinel on Nb₂O₅—ZrO₂ support oxide also confirm an improved ZPGM catalyst activity obtained from the cooperative effect of adding Fe to Cu—Mn spinel on Nb₂O₅—ZrO₂ support oxide, as well as show the effect of Nb₂O₅—ZrO₂ support oxide on performance of Cu—Mn—Fe spinel which increases TWC activity.

In present disclosure, the ZPGM material composition of Cu_{0.5}Mn_{0.5}Fe₂O₄ spinel on Nb₂O₅—ZrO₂ support oxide may provide optimal and stable spinel phase at temperatures lower than about 900° C., operating at R-values close to rich stoichiometric condition for TWC application.

While various aspects and embodiments have been disclosed, other aspects and embodiments may be contemplated. The various aspects and embodiments disclosed here are for purposes of illustration and are not intended to be limiting, with the true scope and spirit being indicated by the following claims.

What is claimed is:

1. A catalyst component, comprising: at least one oxygen storage material having a general formula of CuₓMn₁₋ₓFe₂O₄.

2. The catalyst component of claim 1, wherein the catalyst component is substantially free of rare earth metals.

3. The catalyst component of claim 1, wherein the at least one oxygen storage material is spinel form.

4. The catalyst component of claim 1, further comprising at least one support oxide.

5. The catalyst component of claim 4, wherein the at least one support oxide comprises ZrO₂.

6. The catalyst component of claim 4, wherein the at least one support oxide comprises Nb₂O₅—ZrO₂.

7. The catalyst component of claim 1, wherein the at least one oxygen storage material is stable at temperatures greater than 600° C.

8. The catalyst component of claim 1, wherein the at least one oxygen storage material is stable at temperatures less than 900° C.

9. The catalyst component of claim 1, wherein x is 0.5.

10. The catalyst component of claim 1, wherein NO conversion is about 78%.

11. The catalyst component of claim 1, wherein the at least one oxygen storage material is non-stoichiometric.

12. The catalyst component of claim 1, wherein the at least one oxygen storage material is non-stoichiometric.

13. A catalyst system, comprising:
at least one substrate;
at least one first coating applied to the at least one substrate comprising at least one oxygen storage material; and
wherein the at least one oxygen storage material comprises Cu—Fe—Mn spinel having a niobium-zirconia support oxide; and
wherein the Cu—Fe—Mn spinel has a general formula of CuₓMn₁₋ₓFe₂O₄, wherein the Cu molar ratio is from about x=0.5 to about x=1.0.

14. The catalyst system of claim 13, further comprising at least one second coating comprising Al₂O₃.

15. The catalyst system of claim 13, wherein the at least one first coating is substantially free of platinum group metals.

16. The catalyst system of claim 13, wherein the at least one first coating is substantially free of rare earth metals.

17. The catalyst system of claim 13, wherein the at least one first coating is a washcoat.

18. The catalyst system of claim 13, wherein the T50 of NO is less than 400° C.

19. The catalyst system of claim 13, wherein the T50 of CO is 200° C.

20. The catalyst system of claim 1, wherein rein the at least one oxygen storage material is stable at about 900° C.

21. The catalyst system of claim 1, wherein the at least one oxygen storage material is stable at about 800° C.
